(19) United States
(12) Patent Application Publication
(10) Pub. No.: US 2013/0122485 A1
(43) Pub. Date: May 16, 2013

(54) METHOD OF ANALYZING BIOMATERIALS USING A MAGNETIC BEAD

(71) Applicant: Electronics and Telecommunications Reseach Ins, Daejeon (KR)

(72) Inventor: Hyo Bong HONG, Daejeon (KR)

(73) Assignee: Electronics and Telecommunications Research Institute, Daejeon (KR)

(21) Appl. No.: 13/668,157

(22) Filed: Nov. 2, 2012

(30) Foreign Application Priority Data
Nov. 10, 2011 (KR) 10-2011-0116908

(51) Int. Cl. G01N 27/72

(52) U.S. Cl. 435/5; 436/501; 435/7.1; 435/6.11; 435/7.4

(57) ABSTRACT

Provided are methods of analyzing biomaterials using a magnetic bead. The method may include preparing a bio material including a target material, preparing first and second magnetic beads, the second magnetic bead having a size smaller than that of the first magnetic bead, forming a binding element including the target material bound on the first and second magnetic beads, separating the first magnetic bead from the binding element by using a magnet, and quantifying the target material bound on the second magnetic bead.

### CROSS-REFERENCE TO RELATED APPLICATIONS

This U.S. non-provisional patent application claims priority under 35 U.S.C. §119 to Korean Patent Application No. 10-2011-0116908, filed on Nov. 10, 2011, in the Korean Intellectual Property Office, the entire contents of which are hereby incorporated by reference.

### BACKGROUND OF THE INVENTION

Embodiments of the inventive concepts relate to a method of analyzing a biomaterial, and in particular, methods of analyzing biomaterials using a magnetic bead.

In medical or biotech fields, such as a new drug production or a medical diagnosis, there is a strong requirement for a method capable of exactly detecting and quantifying a biomolecule, such as biomarkers of metabolites or diseases. Binding assay methods, such as imMunoassay, DNA hybridization, or receptor-based assay, are being widely used to analyze the biomolecule. However, it is hard to examine directly whether or not a biomolecule is in a bound state, and thus, in the binding assay, a labeling material is used to indicate the presence or absence of the target molecule in a form of measurable signal. For example, a radioactive material, a fluorescent material, an enzymatic label or a magnetic material may be used as the labeling materials.

A behavior of a magnetic bead can be easily controlled by using a magnetic force. In addition, the magnetic bead has technical advantages, such as high biocompatibility and high detection ability. Accordingly, the magnetic bead is receiving increasing attention as a labeling material in the binding assay.

Conventionally, the magnetic bead is used to separate a target material from a sample, and thus, in order to analyze the target material bound to the magnetic bead, it is necessary to additionally analyze the separated target material by a biochemical analysis method or by conjugating the magnetic bead with a chromophoric material (e.g., a fluorescent material or a horse radish peroxidase (HRP)). However, in this case, the magnetic bead may be aggregated or the target material should be exposed several times to chemicals, and thus, an error in the analysis may increase. For example, in the case of using the fluorescent or chromophoric material, some of the magnetic beads may be covered by others, because the magnetic beads are stacked to have a three-dimensional structure. To overcome this problem, it is necessary to perform an analysis on a label compound labeled with a magnetic material. However, there is a technical difficulty in quantification, because both of a magnetic bead for separation and a label compound for producing a signal are separated.

### SUMMARY

Embodiments of the inventive concepts provide a method capable of analyzing a biomaterial with improved efficiency.

According to example embodiments of the inventive concepts, a method of analyzing a biomaterial may include preparing a bio material including a target material, preparing first and second magnetic beads, the second magnetic bead having a size smaller than that of the first magnetic bead, forming a binding element including the target material bound on the first and second magnetic beads, separating the first magnetic bead from the binding element by using a magnet, and quantifying the target material bound on the second magnetic bead.

In example embodiments, the second magnetic bead has a magnetization intensity smaller than that of the first magnetic bead.

In example embodiments, the first magnetic bead has a diameter ranging from about 100 nm to about 200 nm, and the second magnetic bead has a diameter ranging from about 10 nm to about 100 nm.

In example embodiments, the first and second magnetic beads may include at least one of Fe, Mn, Ni, or Co.

In example embodiments, the first and second magnetic beads may be bound on the target material through an antigen-antibody reaction.

In example embodiments, the first magnetic bead may be bound on the target material through an EDC (1-ethyl-3-[3-dimethylaminopropyl]carbodiimide) chemical reaction or a protein binding, and the second magnetic bead may be bound on the target material through an antigen-antibody reaction.

In example embodiments, the quantifying of the target material may include measuring a magnetization intensity of the second magnetic bead using one of GMR, SQUIDS, Mixed Frequency magnetic Detector.

In example embodiments, the preparing of the first and second magnetic beads may include immobilizing a probe material, which can be specifically reacted with the target material, on surfaces of the first and second magnetic beads.

In example embodiments, the immobilizing of the probe material may be achieved by at least one of a carboxyl group (—COOH), a thiol group (—SH), a hydroxyl group (—OH), a silane group, an amine group, or an epoxy group induced on the surfaces of the first and second magnetic beads.

In example embodiments, a specific reaction between the target material and the probe material may be achieved through at least one of an antigen-antibody reaction, an avidin-biotin reaction, a NeutrAvidin-biotin reaction, a StreptAvidin-biotin reaction, complementary DNA, or immunoglobulin G-protein A, protein G, protein A/G, and protein L.

In example embodiments, the target material may include one selected the group consisting of protein, nucleic acid, virus, cell, organic molecules, or inorganic molecules.

In example embodiments, bio material may include one selected the group consisting of blood, cerebrospinal fluid, serum, plasma, urine, nipple aspirate, fine needle aspirate, tissue lavage such as ductal lavage, saliva, sputum, ascites fluid, liver, kidney, breast, bone, bone marrow, testes, brain, ovary, skin, lung, prostate, thyroid, pancreas, cervix, stomach, intestine, colorectal, brain, bladder, colon, uterine, semen, lymph, vaginal pool, synovial fluid, spinal fluid, head and neck, nasopharynx tumors, amniotic fluid, breast milk, pulmonary sputum or surfactant, urine, fecal matter and other liquid samples of biologic origin.

According to example embodiments of the inventive concepts, a method of analyzing a biomaterial may include preparing a bio material including a target material, preparing first and second magnetic beads having different magnetization intensities from each other, forming a binding element including the target material bound on the first and second magnetic beads, separating the first magnetic bead from the binding element by using a magnet, and quantifying the target material bound on the second magnetic bead.

In example embodiments, the first and second magnetic beads may be different from each other in terms of diameter.

In example embodiments, the first magnetic bead has a diameter greater than that of the second magnetic bead.

In example embodiments, the quantifying of the target material may include measuring a magnetization intensity of the second magnetic bead.

### BRIEF DESCRIPTION OF THE DRAWINGS

Example embodiments will be more clearly understood from the following brief description taken in conjunction with the accompanying drawings. FIGS. 1 through 5 represent non-limiting, example embodiments as described herein.

FIG. 1 is a flow chart schematically illustrating a method of analyzing a biomaterial according to embodiments of the inventive concept.

FIG. 2 is a schematic diagram illustrating a method of analyzing a biomaterial according to a first embodiment of the inventive concept.

FIG. 3 is a graph showing an analysis result of a bio material according to a first experimental example of the inventive concept.

FIG. 4 is a schematic diagram illustrating a method of analyzing a biomaterial according to a second embodiment of the inventive concept.

FIG. 5 is a graph showing an analysis result of a bio material according to a second experimental example of the inventive concept.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION

Example embodiments of the inventive concepts will now be described more fully with reference to the accompanying drawings, in which example embodiments are shown. Example embodiments of the inventive concepts may, however, be embodied in many different forms and should not be construed as being limited to the embodiments set forth herein; rather, these embodiments are provided so that this disclosure will be thorough and complete, and will fully convey the concept of example embodiments to those of ordinary skill in the art. In the drawings, the thicknesses of layers and regions are exaggerated for clarity. Like reference numerals in the drawings denote like elements, and thus their description will be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Like numbers indicate like elements throughout. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments of the inventive concepts belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, a method of analyzing a bio material according to example embodiments of the inventive concepts will be described in more detail with reference to the accompanying drawings.

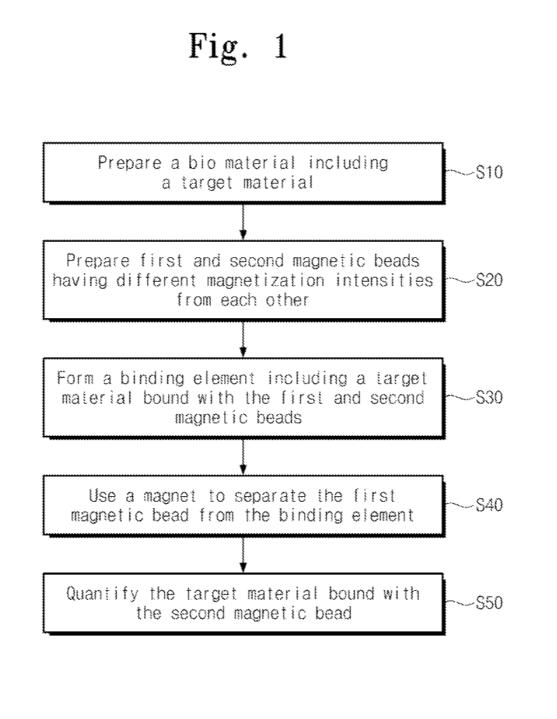

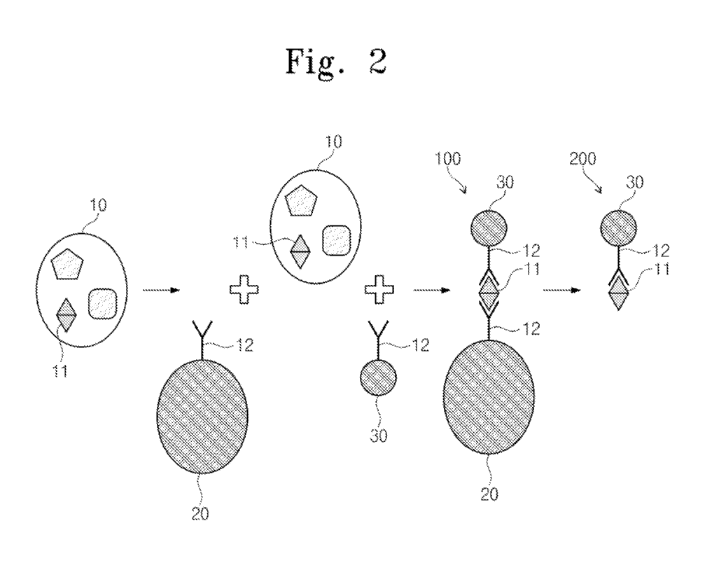

FIG. 1 is a flow chart schematically illustrating a method of analyzing a biomaterial according to embodiments of the inventive concept, and FIG. 2 is a schematic diagram illustrating a method of analyzing a biomaterial according to a first embodiment of the inventive concept.

Referring to FIGS. 1 and 2, a bio material 10 including a target material 11 may be prepared (in S10).

The bio material 10 may include any material derived from the body of a human or an animal, including, but not limited to, blood, cerebrospinal fluid, serum, plasma, urine, nipple aspirate, fine needle aspirate, tissue lavage such as ductal lavage, saliva, sputum, ascites fluid, liver, kidney, breast, bone, bone marrow, testes, brain, ovary, skin, lung, prostate, thyroid, pancreas, cervix, stomach, intestine, colorectal, brain, bladder, colon, uterine, semen, lymph, vaginal pool, synovial fluid, spinal fluid, head and neck, nasopharynx tumors, amniotic fluid, breast milk, pulmonary sputum or surfactant, urine, fecal matter and other liquid samples of biologic origin, and may refer to either the cells or cell fragments suspended therein, or to the liquid medium and its solutes. In addition, the bio material 10 may include not only a target material desired to be detected but also nonspecific molecules that are not bound with the probe materials.

The target material 11 may refer to a bio molecule (e.g., analytes) exhibiting a specific nature. For example, the target material 11 may include protein, nucleic acid, virus, cell, organic molecules, or inorganic molecules. In the case of protein, the target material 11 may be all biomaterials such as antigen, antibody, matrix protein, enzyme and coenzyme. In the case of nucleic acid, the target material 11 may be DNA, RNA, PNA, LNA or a hybrid thereof In example embodiments, the target material 11 may be an antigen.

Thereafter, first and second magnetic beads 20 and 30 having different magnetization intensities from each other may be prepared (in S20).

In example embodiments, the first and second magnetic beads 20 and 30 may have a magnetization intensity depending on a diameter thereof. In other words, the first and second magnetic beads 20 and 30 may be prepared to have different diameters from each other, and this difference in diameter may lead to a difference in magnitude of attractive force caused by the same magnet. For example, in the case where the magnetic bead has a small diameter, it has a reduced magnetic domain and consequently a reduced intensity of magnetization. Here, the magnetic domain may refer to a unit region within a magnetic material, which may have uniform magnetization.

In example embodiments, the first magnetic bead 20 may have a diameter greater than that of the second magnetic bead. As a result, the first magnetic bead 20 may be easily attracted toward the magnet, compared with the second magnetic bead. However, the first magnetic bead 20 may be inferior to the second magnetic bead in a measurement precision of magnetic intensity. In other words, the second magnetic bead 30 may not be attracted by an external magnetic field, owing to its small magnetic domain. Accordingly, the second magnetic bead 30 may have a difficulty in separating the target molecules using a magnet. According to example embodiments of the inventive concept, the quantifying of the target material 11 can be achieved by using this difference (i.e., in magnetic domain size) between the first and second magnetic beads 20 and 30. In other words, the first magnetic bead 20 may be used to separate the target material 11 from the bio material 10, while the second magnetic bead 30 may be used to generate a measurable signal of a magnetic intensity.

In more detail, the first and second magnetic beads 20 and 30 may be nanobeads, whose diameter ranges from about 1 nm to about 200 nm. In addition, a diameter of the second magnetic bead 30 may be smaller than that of the first magnetic bead 20, and a magnetization intensity of the second magnetic bead 30 may be smaller than that of the first magnetic bead 20. For example, the first magnetic bead 20 may have a diameter ranging from about 100 nm to about 200 nm, while the second magnetic bead 30 may have a diameter ranging from about 10 nm to about 100 nm or preferably ranging from about 10 nm to about 50 nm.

In example embodiments, the first and second magnetic beads 20 and 30 may contain at least one of Fe, Mn, Ni, or Co. For example, the first and second magnetic beads 20 and 30 may be formed of at least one of Fe, ε-Co, Co, Ni, FePt, CoPt, γ-Fe₂O₃, Fe₃O₄, CoO, CoFe₂O₄, or Fe-containing alloys.

A surface treatment process may be performed on the first and second magnetic beads 20 and 30, such that the first and second magnetic beads 20 and 30 can have a surface, to which the target material 11 in the bio material 10 can be bound.

In example embodiments, a probe material 12, which can be specifically bound to the target materials 11, may be immobilized on surfaces of the first and second magnetic beads 20 and 30 by a chemical method.

In some aspects of the inventive concept, the probe material 12 may be a bio molecule (e.g., a receptor or an acceptor), which can be specifically bound to the target material 11. For example, the probe material 12 may be one of antibody, antigen, DNA, biotin, avidin, and streptavidin. For the sake of simplicity, the description that follows will refer to an example of the present embodiment in which the probe material 12 is an antibody.

In example embodiments, the probe material 12 may be immobilized on the surfaces of the first and second magnetic beads 20 and 30 through a chemical adsorption, a covalent bonding, an electrostatic attraction, a co-polymerization, or an avidin-biotin affinity system.

In example embodiments, a functional group may be induced in order to strengthen the immobilization of the probe material 12. For example, a carboxyl group (—COOH), a thiol group (—SH), a hydroxyl group (—OH), a silane group, an amine group, or an epoxy group may be used as the functional group.

In addition to the probe material 12, casein may be immobilized on the surfaces of the first and second magnetic beads 20 and 30 to serve as a blocking material (not shown) blocking a nonspecific binding of the target material 11.

Thereafter, the bio material 10 and the first and second magnetic beads 20 and 30 may be mixed to form a binding element 100 including the target material 11 bound with the first and second magnetic beads 20 and 30 (in S30).

If the target material 11 is provided onto the surfaces of the first and second magnetic beads 20 and 30 immobilized with the probe material 12, the target material 11 may be immobilized around the first and second magnetic beads 20 and 30 through a specific reaction with the probe material 12. The specific reaction between the probe material 12 and the target material 11 may be achieved through at least one of an antigen-antibody reaction, an avidin-biotin reaction, a NeutrAvidin-biotin reaction, a StreptAvidin-biotin reaction, complementary DNA, or immunoglobulin G-protein A, protein G, protein A/G, and protein L.

Thereafter, a magnet may be used to separate the first magnetic bead 20 from the binding element 100 (in S40).

Since the first magnetic bead 20 may have magnetic domains, unlike the second magnetic bead 30, the first magnetic bead 20 may be pulled toward the magnet. Accordingly, the first magnetic bead 20 may be separated from the binding element 100, such that the binding element 100 may contain the target material 11 bound with the second magnetic bead 30.

Next, referring to FIG. 1, the target material 11 bound with the second magnetic bead 30 may be quantified (in S50).

In example embodiments, the quantifying of the target material 11 bound with the second magnetic bead 30 may include converting an amount or presence of the second magnetic bead 30 on the target material 11 into an electrochemical or electrical signal. The presence of the target material 11 may be quantitatively examined by analyzing the electrochemical or electrical signal.

In example embodiments, the quantifying of the target material 11 may include measuring a magnetization intensity of the second magnetic bead 30 using one of a giant magneto-resistance (GMR) sensor, superconducting quantum interference devices (SQUIDS), or a mixed-frequency magnetic detector.

According to example embodiments of the inventive concepts, the presence of the bio material 10 can be simply and quantitatively examined by sensing the signal corresponding to the number of the second magnetic bead 30. As a result, it is possible to obtain stably experimental data. In addition, various experiments for separating or analyzing the target material 11 can be performed, even in the open air, not in a laboratory.

### FIRST EXPERIMENTAL EXAMPLE

In a first experimental example, a second magnetic bead (for generating a signal) may be separated using a chemical or biochemical feature of a treated surface, not by a magnet. The first experimental example shows that a magnetic property of the second magnetic bead can be interpreted as an electrical signal.

In the first experimental example, 50 nm and 100 nm magnetic beads (from Chemicell, Eresburgstrasse 22-23, 12103 Berlin, Germany) were prepared as the first and second magnetic beads. (Fluid MAG-ARA and FluidMAG biotin).

[Preparing 50 nm Magnetic Beads]

1) A surface treatment process was performed on the 50 nm magnetic beads to immobilize specific biological or chemical material thereon. In detail, the 50 nm magnetic beads (100 ul) were dissolved in a 900 ul MES (2-(N-Morpholino)ethansulfonic acid) buffer solution (pH 5.6).

2) A centrifugal separation process was performed on the resultant solution in 14,000 rpm for 10 minutes and then a washing process was performed on the 50 nm magnetic beads, because the 50 nm magnetic beads were not separated by a magnet.

3) The steps 1 and 2 were repeated two times, and then, the 50 nm magnetic beads were dissolved in a MES buffer solution (250 ul).

4) EDC (1-ethyl-3-(3-dimethylaminopropyl) carbodiimice) (10 mg) was dissolved in a MES buffer solution.

5) The solutions prepared in the steps 3 and 4 were mixed and incubated for 10 minutes at room temperature.

6) The steps 1 and 2 were repeated two times, and then, the 50 nm magnetic beads were dissolved in a MES buffer solution (250 ul).

7) Avidin (50 ug) was dissolved in a 250 ul MES buffer solution, was mixed with the MES buffer solution, and then, was reacted with the MES buffer solution for 2 hours at room temperature in a soft mixing manner.

8) The steps 1 and 2 were repeated, and then, the 50nm magnetic beads were dissolved in 500 ul PBS (Phosphate Buffer Saline) solution (pH 7.4). 100 ug biotin was dissolved in and reacted with the PBS solution for 30 minutes, was centrifugally separated, and then, was stored in PBS solution.

9) For a long-term storing, it was dissolved in a PBS solution containing 0.1% BSA and 0.05% thimerasol.

[Preparing 100 nm Magnetic Beads]

10) FluidMAG biotin (from Chemicell) diluted at 10,000-fold was used as 100 nm magnetic beads for separating the target material 11. Washing and diluting processes were performed with PBS solutions, and 100 nm magnetic beads were separated by using a magnet.

11) 100 ul avidin (1.0 ug/ml) was added in and reacted, for 10 minutes, with the PBS solution (100 ul) prepared in the step 10, and the PBS solution was used to wash it.

[Mixing 50 nm and 100 nm Magnetic Beads With Target Material]

12) The PBS solution (50 ul) containing 50 nm magnetic beads was mixed with the PBS solution (50 ul) containing 100 nm magnetic beads, and they were incubated for 20 minutes.

13) The 100 nm magnetic beads were separated from the incubated mixture using a magnet, and were mixed with a 100 ul PBS solution. Thereafter, a magnetic intensity of the magnetic beads included in the mixture was measured.

[Preparing Comparative Samples]

Samples 1 and 2 were prepared for comparison with the first experimental example.

The sample 1 was a solution (100 ul) prepared to contain only FluidMAG biotin 100 nm magnetic beads. For the sample 2, 100 nm magnetic beads were separated from a diluted solution containing 100 nm and 50 nm magnetic bead solutions, which the surface treatment process has not been applied to, by using a magnet, and then, a magnetic intensity of the magnetic beads included in 100 ul solution was measured. The sample 2 was prepared in a state, in which only the 100 mm magnetic beads were separated, because a complementary material (e.g., biotin+Avidin) was not immobilized on surfaces of 100 nm and 50 nm magnetic beads.

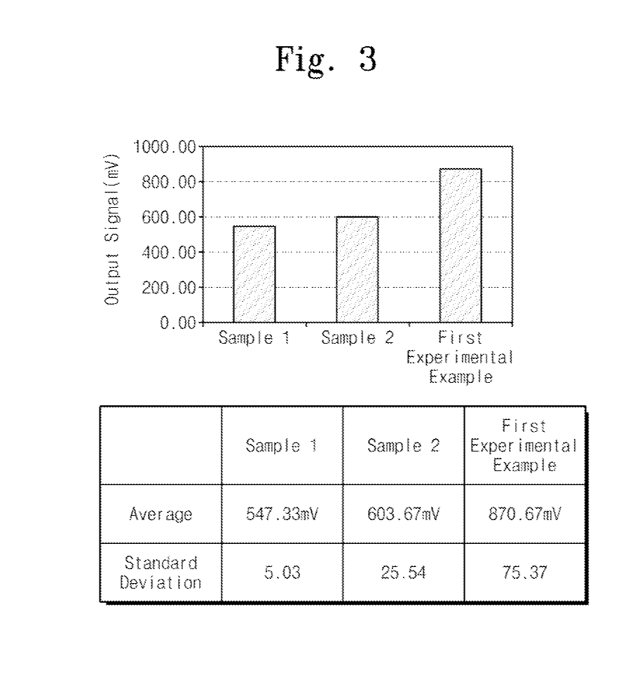

FIG. 3 is a graph comparatively showing analysis results of the bio material according to the first experimental example and the samples 1 and 2.

In FIG. 3, the vertical axis represents electrical signals (mV) measured from the sample according to the first experimental example and the samples 1 and 2. The result of FIG. 3 shows that the sample according to the first experimental example can be used to quantify a target material.

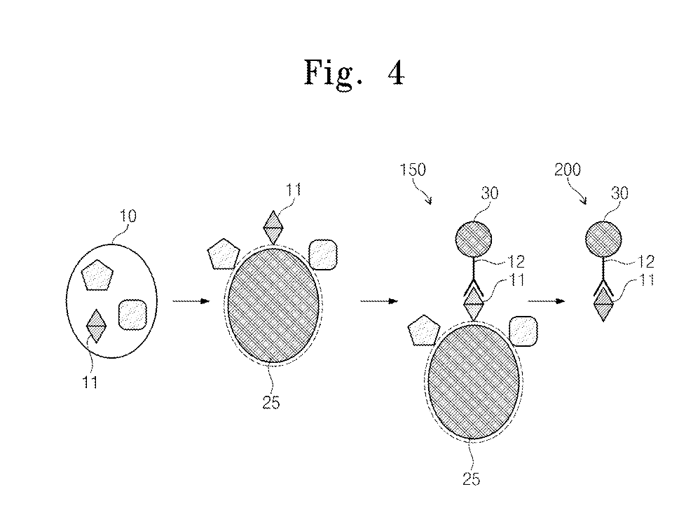

FIG. 4 is a schematic diagram illustrating a method of analyzing a biomaterial according to a second embodiment of the inventive concept. The second embodiment may differ from the first embodiment, in that a chemical surface treatment may be used for a process of making the first magnetic bead have a surface, on which a protein can be bound.

Referring to FIG. 4, a method of analyzing the bio material 10 according to the second embodiment may include, as described with reference to FIG. 1, preparing the bio material 10 containing the target material 11, preparing first and second magnetic beads 25 and 30 having different magnetization intensities from each other, mixing the target material 11 with the first and second magnetic beads 25 and 30 to form a binding element 150, separating the first magnetic bead 25 from the binding element 150 by using a magnet, and then, quantifying the target material 11 bound with the second magnetic bead 30.

In the present embodiment, the preparation of the first magnetic bead 25 may include binding biomolecules onto a surface of first magnetic bead 25. Here, not only the target material 11 but also molecules having other specific nature may be bound to a surface of the first magnetic bead 25. For example, a protein may be bound to the surface of the first magnetic bead 25. In other words, antigen, antibody, matrix protein, enzyme, coenzyme, and so forth may be bound to the surface of the first magnetic bead 25. In example embodiments, the step of binding a protein to the surface of the first magnetic bead 25 may be performed through a chemical reaction, in which EDC (1-ethyl-3-(3-dimethylaminopropyl)carbodiimice) may be used.

As described with respect to the first embodiment, the preparation of the second magnetic bead 30 may include immobilizing the probe material 12, which can be bound with the target material 11, on surfaces of the second magnetic beads 30.

In the present embodiment, if the target material 11 is mixed with the first and second magnetic beads 25 and 30, the target material 11, which may be one of biomolecules bound on the first magnetic bead 25, may be specifically bound with the probe material 12 bound on the second magnetic bead 30. As a result, a binding element 150 may be formed to include the target material 11 bound on the first and second magnetic beads 25 and 30, as shown in FIG. 4.

Thereafter, as described with respect to the first embodiment, the first magnetic bead 25 may be separated by using a magnet, and the binding element 150 may be washed to obtain a binding element 200 including the target material 11 bound on the second magnetic bead 30.

### SECOND EXPERIMENTAL EXAMPLE

According to a second experimental example, a specific reaction between beta-amyloid and beta-amyloid antibody may be used to bind magnetic beads with a target material.

[Preparing 50 nm Magnetic Beads]

1) 50 nm magnetic beads (100 ul) were dissolved in a 900 ul MES solution (pH 5.6).

2) A centrifugal separation process was performed on the resultant solution in 14,000 rpm for 10 minutes and then a washing process was performed on 50 nm magnetic beads, because the 50 nm magnetic beads were not separated by a magnet.

3) The steps 1 and 2 were repeated two times, and then, the 50 nm magnetic beads were dissolved in a MES solution (250 ul).

4) 10 mg EDC was dissolved in a MES solution (250 ul) containing the 50 nm magnetic beads.

5) The solutions prepared in the steps 3 and 4 were mixed and incubated for 10 minutes at room temperature.

6) The steps 1 and 2 were repeated two times, and then, the 50 nm magnetic beads were dissolved in a MES solution (250 ul).

7) 10 mg EDC was dissolved in a MES solution (250 ul).

8) The solutions prepared in the steps 6 and 7 were mixed and incubated for 10 minutes at room temperature.

9) The steps 1 and 2 were repeated two times, and then, the 50 nm magnetic beads were dissolved in a MES solution (250 ul).

10) Rabbit anti human beta amyloid 1-40/42 polyclonal antibody (Millipore, Calif., US) (50 ul) was dissolved in a 250 ul MES solution, and then, was mixed with and reacted with the solution prepared in the step 6 for 2 hours at room temperature.

11) The steps 1 and 2 were repeated, and then, the 50 nm magnetic beads were dissolved in 500 ul PBS solution (pH 7.4), not in the MES solution. For a long-term storing, it was dissolved in a PBS solution containing 0.1% BSA and 0.05% thimerasol.

[Preparing 100 nm Magnetic Beads]

12) 100 nm magnetic beads (100 ul) were dissolved in a 900 ul MES solution (pH 5.6).

13) The steps 1 and 2 were repeated two times, and then, the 100 nm magnetic beads were dissolved in a MES solution (250 ul).

14) 10 mg EDC was dissolved in a MES solution (250 ul) containing the 100 nm magnetic beads.

15) The solutions prepared in the steps 13 and 14 were mixed and incubated for 10 minutes at room temperature.

16) The steps 1 and 2 were repeated two times, and then, the 100 nm magnetic beads were dissolved in a MES solution (250 ul).

17) Beta amyloid 1-40 (Sigma Aldrich) (5 ug) and BSA (Bovine Serum Albumin) (45 ug) were dissolved in a 250 ul MES solution, and then, was mixed with and reacted with the solution prepared in the step 16 for 2 hours at room temperature.

18) The solution prepared in the step 17 was washed two times and dissolved in a PBS solution.

[Mixing the 50 nm and 100 nm Magnetic Beads with the Target Material]

19) The solution (50 ul) prepared in the step 14 was mixed with the solution (50 ul) prepared in the step 18, and they were incubated for 20 minutes. Next, the 100 nm magnetic beads were separated from the incubated mixture using a magnet, and were mixed with a 100 ul PBS solution. Thereafter, a magnetic intensity of the magnetic beads included in the mixture was measured.

[Preparing Comparative Samples]

Samples 1 and 2 were prepared for comparison with the second experimental example.

The sample 1 was a solution (100 ul) prepared to contain only FluidMAG biotin 100 nm magnetic beads. For the sample 2, 100 nm magnetic beads were separated from a diluted solution containing 100 nm and 50 nm magnetic bead solutions, which the surface treatment process has not been applied to, by using a magnet, and then, a magnetic intensity of the magnetic beads included in 100 ul solution was measured. The sample 2 was prepared in a state, in which only the 100 mm magnetic beads were separated, because a complementary material (e.g., biotin+Avidin) was not immobilized on surfaces of 100 nm and 50 nm magnetic beads.

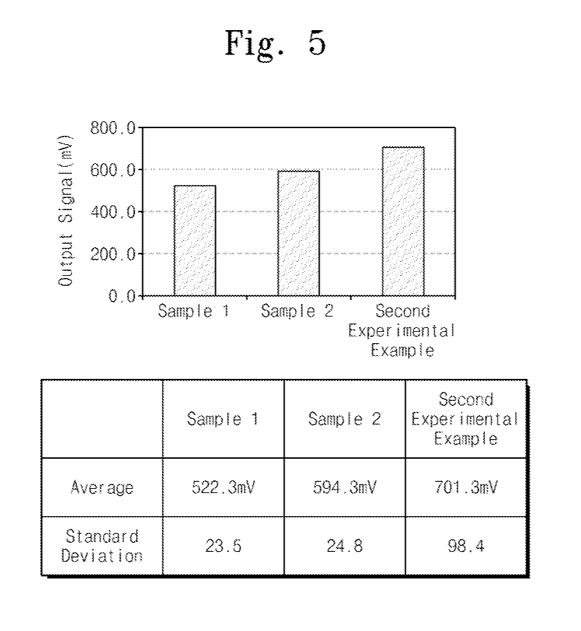

FIG. 5 is a graph showing an analysis result of the bio material according to a second experimental example of the inventive concept.

The graph shown in FIG. 5 was obtained from a target material analysis using a specific reaction between beta-amyloid and beta-amyloid antibody. In FIG. 5, the vertical axis represents electrical signals (mV) measured from the sample according to the second experimental example and the samples 1 and 2. The result of FIG. 5 shows that the sample according to the second experimental example can be used to quantify a target material.

According to example embodiments of the inventive concepts, a biomaterial may be analyzed using two kinds of magnetic beads, whose magnetization intensities are different from each other. In addition, there is no necessity to store or prepare a reagent required to quantify a biomaterial, and thus, an analysis of a biomaterial can be promptly performed. Furthermore, it is possible to relieve technical problems in conventional reagents, such as, being sensitive to a light, humidity, and temperature, and it is possible to store or re-analyze samples, unlike the case of conventional biochemical reagent. Even in the case where there is no high cost equipment or no trained person, it is possible to analyze bio materials, for example, in a military or at the hinterland, with ease.

While example embodiments of the inventive concepts have been particularly shown and described, it will be understood by one of ordinary skill in the art that variations in form and detail may be made therein without departing from the spirit and scope of the attached claims.

What is claimed is:

1. A method of analyzing a biomaterial, comprising:
preparing a bio material including a target material;
preparing first and second magnetic beads, the second magnetic bead having a size smaller than that of the first magnetic bead;
forming a binding element including the target material bound on the first and second magnetic beads;
separating the first magnetic bead from the binding element by using a magnet; and
quantifying the target material bound on the second magnetic bead.

2. The method of claim 1, wherein the second magnetic bead has a magnetization intensity smaller than that of the first magnetic bead.

3. The method of claim 1, wherein the first magnetic bead has a diameter ranging from about 100 nm to about 200 nm, and the second magnetic bead has a diameter ranging from about 10 nm to about 100 nm.

4. The method of claim 1, wherein the first and second magnetic beads includes at least one of Fe, Mn, Ni, or Co.

5. The method of claim 1, wherein the first and second magnetic beads are bound on the target material through an antigen-antibody reaction.

6. The method of claim 1, wherein the first magnetic bead is bound on the target material through an EDC (1-ethyl-3-[3-dimethylaminopropyl]carbodiimide) chemical reaction or a protein binding, and
the second magnetic bead is bound on the target material through an antigen-antibody reaction.

7. The method of claim 1, wherein the quantifying of the target material includes measuring a magnetization intensity of the second magnetic bead using one of GMR, SQUIDS, Mixed Frequency magnetic Detector.

8. The method of claim 1, wherein the preparing of the first and second magnetic beads includes immobilizing a probe material, which can be specifically reacted with the target material, on surfaces of the first and second magnetic beads.

9. The method of claim 8, wherein the immobilizing of the probe material is achieved by at least one of a carboxyl group (—COOH), a thiol group (—SH), a hydroxyl group (—OH), a silane group, an amine group, or an epoxy group induced on the surfaces of the first and second magnetic beads.

10. The method of claim 8, wherein a specific reaction between the target material and the probe material is achieved through at least one of an antigen-antibody reaction, an avidin-biotin reaction, a NeutrAvidin-biotin reaction, a StreptAvidin-biotin reaction, complementary DNA, or immunoglobulin G-protein A, protein G, protein A/G, and protein L.

11. The method of claim 1, wherein the target material includes one selected the group consisting of protein, nucleic acid, virus, cell, organic molecules, or inorganic molecules.

12. The method of claim 1, wherein the bio material includes one selected the group consisting of blood, cerebrospinal fluid, serum, plasma, urine, nipple aspirate, fine needle aspirate, tissue lavage such as ductal lavage, saliva, sputum, ascites fluid, liver, kidney, breast, bone, bone marrow, testes, brain, ovary, skin, lung, prostate, thyroid, pancreas, cervix, stomach, intestine, colorectal, brain, bladder, colon, uterine, semen, lymph, vaginal pool, synovial fluid, spinal fluid, head and neck, nasopharynx tumors, amniotic fluid, breast milk, pulmonary sputum or surfactant, urine, fecal matter and other liquid samples of biologic origin.

13. A method of analyzing a biomaterial, comprising:
preparing a bio material including a target material;
preparing first and second magnetic beads having different magnetization intensities from each other;
forming a binding element including the target material bound on the first and second magnetic beads;
separating the first magnetic bead from the binding element by using a magnet; and
quantifying the target material bound on the second magnetic bead.

14. The method of claim 13, wherein the first and second magnetic beads are different from each other in terms of diameter.

15. The method of claim 13, wherein the first magnetic bead has a diameter greater than that of the second magnetic bead.

16. The method of claim 13, wherein the quantifying of the target material includes measuring a magnetization intensity of the second magnetic bead.
